(19) United States
(12) Patent Application Publication
(10) Pub. No.: US 2019/0188987 A1
(43) Pub. Date: Jun. 20, 2019

(54) SIMPLE ALARM FOR UNDERGROUND SOIL LOSS

(71) Applicant: SHENZHEN UNIVERSITY, Shenzhen (CN)

(72) Inventors: Dong SU, SHENZHEN (CN); Junjie HUANG, SHENZHEN (CN); Zhongliang YU, SHENZHEN (CN)

(21) Appl. No.: 16/221,574

(22) Filed: Dec. 16, 2018

Related U.S. Application Data
(63) Continuation of application No. PCT/CN2018/093999, filed on Jul. 2, 2018.

(30) Foreign Application Priority Data
Dec. 15, 2017 (CN) 201711348857.2

(51) Int. Cl. G08B 21/10; G08B 3/10

(52) U.S. Cl. CPC G08B 21/10; G01V 9/00; G08B 3/10

(57) ABSTRACT

A simple alarm for underground soil loss, includes an insulating installing box and an alarm loop, a rotating shaft is disposed in the insulating installing box; the rotating shaft is provided with a spring torque gauge; a bottom end of the rotating shaft is connected with a pozidriv cross recessed plate head; the spring torque gauge is connected with a first conductive metal sheet; the insulating installing box is connected with a second conductive metal sheet; the second conductive metal sheet is disposed on a motion track formed by that the first conductive metal sheet moves around the rotating shaft; the spring torque gauge, the first and second conductive metal sheets are positioned in the insulating installing box; the pozidriv cross recessed plate head is positioned outside the insulating installing box; and the first and second conductive metal sheets are arranged on the alarm loop.

### CROSS-REFERENCE TO RELATED APPLICATIONS

This application is a continuation of International Patent Application No. PCT/CN2018/093999 with a filing date of Jul. 2, 2018, designating the United States, now pending, and further claims priority to Chinese Patent Application No. 201711348857.2 with a filing date of Dec. 15, 2017. The content of the aforementioned applications, including any intervening amendments thereto, are incorporated herein by reference.

### TECHNICAL FIELD

The present disclosure relates to an alarm for soil loss, and particularly relates to a simple alarm for underground soil loss.

### BACKGROUND OF THE PRESENT INVENTION

At present, there is no alarm for underground soil loss, and underground soil loss and subsidence cannot be alarmed.

### SUMMARY OF PRESENT INVENTION

To solve the problem in the prior art, the present disclosure provides a simple alarm for underground soil loss.

The present disclosure provides a simple alarm for underground soil loss, including an insulating installing box and an alarm loop, a rotating shaft is disposed in the insulating installing box; the rotating shaft is provided with a spring torque gauge; a bottom end of the rotating shaft is connected with a plate head; the spring torque gauge is connected with a first conductive metal sheet; the insulating installing box is connected with a second conductive metal sheet; the second conductive metal sheet is disposed on a motion track formed by that the first conductive metal sheet moves around the rotating shaft; the spring torque gauge, the first conductive metal sheet and the second conductive metal sheet are positioned in the insulating installing box; the plate head is positioned outside the insulating installing box; and the first conductive metal sheet and the second conductive metal sheet are arranged on the alarm loop.

As a further improvement of the present disclosure, the first conductive metal sheet is connected with the spring torque gauge through a first insulating strut; and the second conductive metal sheet is connected with the insulating installing box through a second insulating strut.

As a further improvement of the present disclosure, a top end of the rotating shaft is connected with a detachable shaft rod and a fixed handle; the detachable shaft rod is connected with a detachable handle; and the fixed handle is provided with a fixing bolt for fixing the fixed handle to the insulating installing box.

As a further improvement of the present disclosure, the alarm loop includes a power supply and an alarm device; the power supply is connected with the first conductive metal sheet through a cable; the power supply is connected with the alarm device through a cable; and the alarm device is connected with the second conductive metal sheet through a cable.

As a further improvement of the present disclosure, if the first conductive metal sheet comes into contact with the second conductive metal sheet, the first conductive metal sheet, the power supply, the alarm device and the second conductive metal sheet form a closed loop.

As a further improvement of the present disclosure, a bracket is disposed in the insulating installing box; and the power supply is fixed to the bracket.

As a further improvement of the present disclosure, the insulating installing box is connected with a metal cover plate; the alarm device includes an alarm and a buzzer, the alarm and the buzzer are respectively disposed on the metal cover plate; the alarm is connected with the power supply through a cable; the buzzer is connected with the second conductive metal sheet through a cable; and the alarm is connected with the buzzer through the metal cover plate.

As a further improvement of the present disclosure, the plate head is a pozidriv cross recessed plate head.

The present disclosure has the following beneficial effects: through the above solution, the simple alarm for underground soil loss is provided, which can alarm the underground soil loss and subsidence and it is simple in structure, light in weight and convenient in use.

### DESCRIPTION OF THE DRAWINGS

FIG. 1 is an entire schematic diagram of a simple alarm for underground soil loss in the present disclosure;

FIG. 2 is a schematic diagram of a simple alarm for underground soil loss before alarming in the present disclosure; and

FIG. 3 is a schematic diagram of a simple alarm for underground soil loss after alarming in the present disclosure.

### DETAILED DESCRIPTION OF PREFERRED EMBODIMENTS

The present disclosure will be further described below in combination with accompanying drawings and specific embodiments.

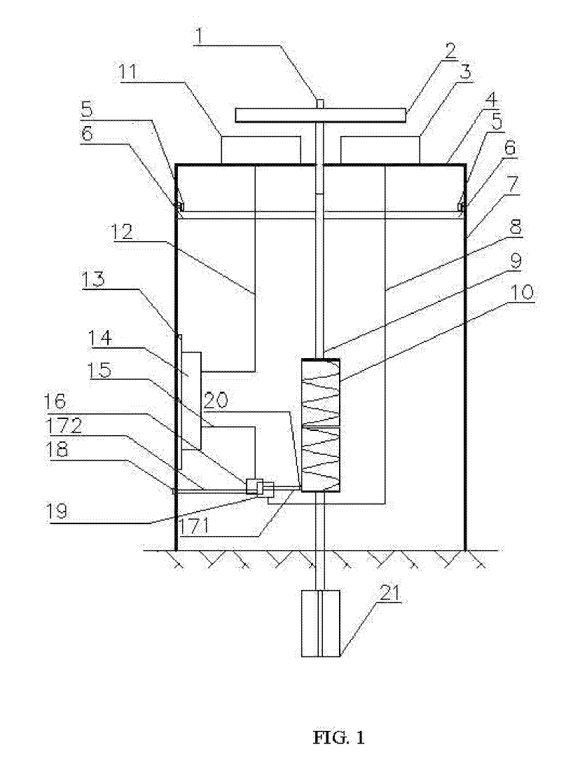

As shown in FIG. 1 to FIG. 3, a simple alarm for underground soil loss includes an insulating installing box 7 and an alarm loop. A rotating shaft 9 is disposed in the insulating installing box 7. The rotating shaft 9 is provided with a spring torque gauge 10. A bottom end of the rotating shaft 9 is connected with a plate head 21. The spring torque gauge 10 is connected with a first conductive metal sheet 16. The insulating installing box 7 is connected with a second conductive metal sheet 19. The second conductive metal sheet 19 is disposed on a motion track formed by that the first conductive metal sheet 16 moves around the rotating shaft 9. The spring torque gauge 10, the first conductive metal sheet 16 and the second conductive metal sheet 19 are positioned in the insulating installing box 7. The plate head 21 is positioned outside the insulating installing box 7; and the first conductive metal sheet 16 and the second conductive metal sheet 19 are arranged on the alarm loop.

As shown in FIG. 1 to FIG. 3, the first conductive metal sheet 16 is connected with the spring torque gauge 10 through a first insulating strut 171 and a fixing bolt 20; and the second conductive metal sheet 19 is connected with the insulating installing box 7 through a second insulating strut 172 and a fixing bolt 18.

As shown in FIG. 1 to FIG. 3, a top end of the rotating shaft 9 is connected with a detachable shaft rod 1 and a fixed handle 5. The detachable shaft rod 1 is connected with a detachable handle 2; and the fixed handle 5 is provided with a fixing bolt 5 for fixing the fixed handle 5 to the insulating installing box 7.

As shown in FIG. 1 to FIG. 3, the alarm loop includes a power supply 14 and an alarm device. The power supply 14 is connected with the first conductive metal sheet 16 through a cable 15. The power supply 14 is connected with the alarm device through a cable; and the alarm device is connected with the second conductive metal sheet 19 through a cable.

As shown in FIG. 1 to FIG. 3, if the first conductive metal sheet 16 comes into contact with the second conductive metal sheet 19, the first conductive metal sheet 16, the power supply 14, the alarm device and the second conductive metal sheet 19 form a closed loop.

As shown in FIG. 1 to FIG. 3, a bracket 13 is disposed in the insulating installing box 7; and the power supply 14 is fixed to the bracket 13.

As shown in FIG. 1 to FIG. 3, the insulating installing box 7 is connected with a metal cover plate 4. The alarm device includes an alarm 11 and a buzzer 3. The alarm 11 and the buzzer 3 are respectively disposed on the metal cover plate 4. The alarm 11 is connected with the power supply 14 through a cable 12. The buzzer 3 is connected with the second conductive metal sheet 19 through a cable 8. The alarm 11 is connected with the buzzer 3 through the metal cover plate 4.

As shown in FIG. 1 to FIG. 3, the plate head 21 is a pozidriv cross recessed plate head.

As shown in FIG. 1 to FIG. 3, in the simple alarm for underground soil loss provided in the present disclosure, the shear strength of local soil needs to be measured in advance. Similar strata are selected near an observation point. Test soil is smoothed using tools such as geotechnical cutters and shovels, and an enough working plane is reserved. The shear strength of a soil sample is estimated to select an appropriate plate head. The plate head is held. A pointer is rotated anticlockwise to 0 scale. Constant vertical pressure is kept to vertically insert the cross plate head into the soil for a certain depth which shall be less than 3 m. The handle above a meter is rotated clockwise at a rate of 5-10 s per circle until the soil is shorn and destroyed. The rotating angle of the handle is recorded. After the soil is shorn and destroyed, spring torsion is released slowly. A reading shown on the pointer of the spring torque gauge 10 is recorded. The shear strength of the soil can be computed by substituting the reading into a formula.

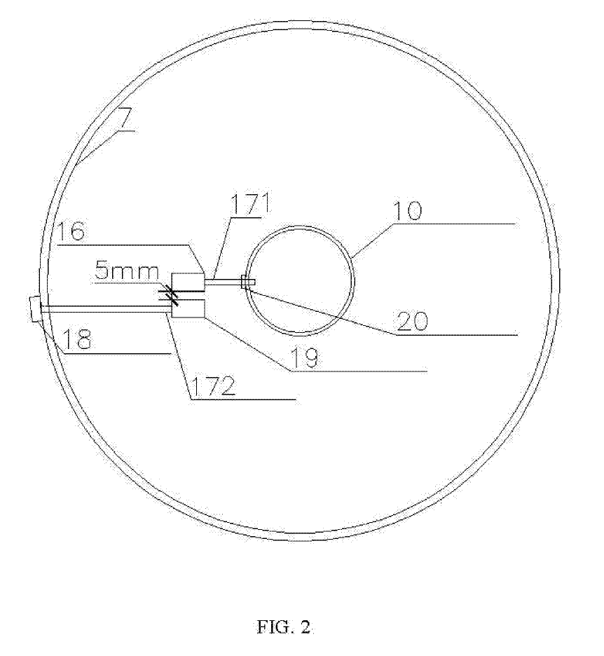

When the simple alarm for underground soil loss is installed, after concrete floor and hard soil layers on the surface are drilled out with a driller, the insulating installing box 7 made of insulating material is installed and the shear strength of the soil sample is estimated to select an appropriate pozidriv cross recessed plate head. The pozidriv cross recessed plate head is held. The pointer is rotated anticlockwise to 0 scale. Constant vertical pressure is kept to press the plate head 21 into the soil sample for a certain depth which shall be less than 3 m. The detachable handle 2 above the meter is rotated clockwise at a rate of 5-10 s per circle. The rotating angle is 80% of a rotating angle required for shearing and destroying the sample. After the detachable handle 2 is rotated to an expected angle, the fixed handle 6 is locked to the insulating installing box 4 using the fixing bolt 5. The detachable shaft rod 1 and the detachable handle 2 are detached. The position of the bracket 13 is adjusted, and the power supply 14 is connected with the first conductive metal sheet 16 through the cable 15. The first conductive metal sheet 16 is fixed to the lower part of the spring torque gauge 10 through the fixing bolt 20 and the first insulating strut 171. The second conductive metal sheet 19 is installed near the first conductive metal sheet 16. A distance between the first conductive metal sheet 16 and the second conductive metal sheet 19 is kept as 5 mm (as shown in FIG. 2). The second conductive metal sheet 19 is fixed to the insulating installing box 7 through the second insulating strut 172 and the fixing bolt 18. The metal cover plate 4 is installed, and the alarm 11 is connected with the power supply 14 through the cable 12. The buzzer 3 is connected with the second conductive metal sheet 19 through the cable 8.

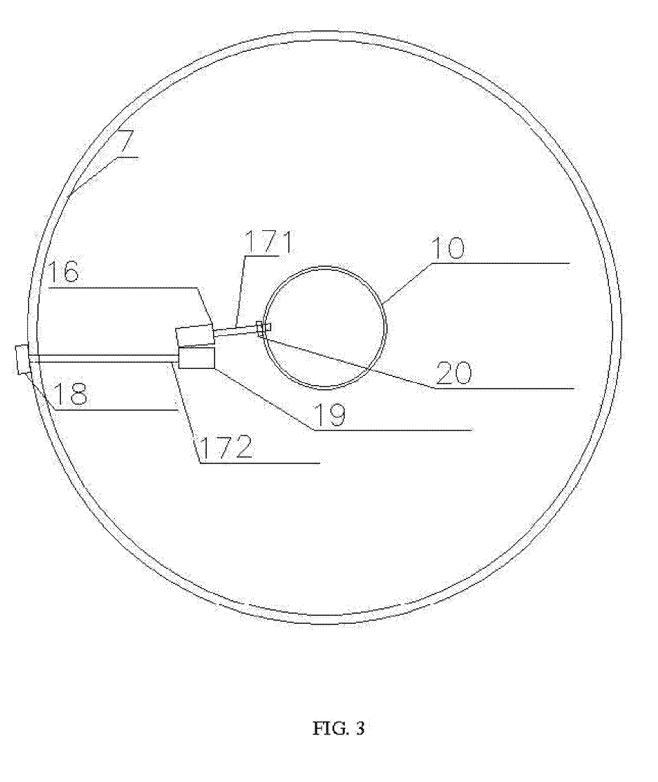

After the soil at the depth of the pozidriv cross recessed plate head below the observation point is washed away by underground water and is lost, the lower half of the spring torque gauge 10 rotates, so that the first conductive metal sheet 16 comes into contact with the second conductive metal sheet 19 (as shown in FIG. 3). The power supply 14, the first conductive metal sheet 16, the second conductive metal sheet 19, the buzzer 3 and the alarm 11 form a closed loop under the connection of the cables, thereby achieving the purpose of alarming subsidence disasters.

The simple alarm for underground soil loss provided in the present disclosure is used in regions with abundant underground water and serious soil loss disasters, and achieves the purpose of alarming underground soil loss on site and possible subsidence. The simple alarm for underground soil loss has the advantages of simple structure, convenient carrying, simple operation steps, economy and practicability, is suitable for soil layers of different depths and strengths, and has good popularization and application prospects.

The simple alarm for underground soil loss provided in the present disclosure has the following advantages:

(1) The simple alarm for underground soil loss has simple structure, light weight and simple operation steps, and is suitable for field use.

(2) The simple alarm for underground soil loss can conveniently alarm underground soil loss and subsidence, and can effectively protect human life and property.

(3) Circuit design is relatively simple, and troubleshooting is convenient.

(4) The simple alarm for underground soil loss can alarm soil loss for different soil layers of different depths, and has wide application range.

(5) An entire measurement system is in a completely sealed box body, and is less disturbed by outside climate conditions, so the alarm is more accurate and effective.

The above contents are further detailed descriptions of the present disclosure in combination with specific preferred embodiments. However, the specific implementation of the present disclosure shall not be considered to be only limited to these descriptions. For those of ordinary skill in the art, several simple deductions or replacements may be made without departing from the conception of the present disclosure, all of which shall be considered to belong to the protection scope of the present disclosure.

We claim:

1. A simple alarm for underground soil loss, comprising an insulating installing box and an alarm loop, wherein a rotating shaft is disposed in the insulating installing box; the rotating shaft is provided with a spring torque gauge; a bottom end of the rotating shaft is connected with a pozidriv cross recessed plate head; the spring torque gauge is connected with a first conductive metal sheet; the insulating installing box is connected with a second conductive metal sheet; the second conductive metal sheet is disposed on a motion track formed by that the first conductive metal sheet moves around the rotating shaft; the spring torque gauge, the first conductive metal sheet and the second conductive metal sheet are positioned in the insulating installing box; the pozidriv cross recessed plate head is positioned outside the insulating installing box; and the first conductive metal sheet and the second conductive metal sheet are arranged on the alarm loop.

2. The simple alarm according to claim 1, wherein the first conductive metal sheet is connected with the spring torque gauge through a first insulating strut; and the second conductive metal sheet is connected with the insulating installing box through a second insulating strut.

3. The simple alarm according to claim 1, wherein a top end of the rotating shaft is connected with a detachable shaft rod and a fixed handle; the detachable shaft rod is connected with a detachable handle; and the fixed handle is provided with a fixing bolt for fixing the fixed handle to the insulating installing box.

4. The simple alarm according to claim 1, wherein the alarm loop comprises a power supply and an alarm device; the power supply is connected with the first conductive metal sheet through a cable; the power supply is connected with the alarm device through a cable; and the alarm device is connected with the second conductive metal sheet through a cable.

5. The simple alarm according to claim 4, wherein if the first conductive metal sheet comes into contact with the second conductive metal sheet, the first conductive metal sheet, the power supply, the alarm device and the second conductive metal sheet form a closed loop.

6. The simple alarm according to claim 4, wherein a bracket is disposed in the insulating installing box; and the power supply is fixed to the bracket.

7. The simple alarm according to claim 4, wherein the insulating installing box is connected with a metal cover plate; the alarm device comprises an alarm and a buzzer the alarm and the buzzer are respectively disposed on the metal cover plate; the alarm is connected with the power supply through a cable; the buzzer is connected with the second conductive metal sheet through a cable; and the alarm is connected with the buzzer through the metal cover plate.
